(19) United States
(12) Patent Application Publication
(10) Pub. No.: US 2017/0194111 A1
(43) Pub. Date: Jul. 6, 2017

(54) A SWITCHING DEVICE FOR A MV ELECTRIC POWER DISTRIBUTION NETWORK

(71) Applicant: ABB Schweiz AG, Baden (CH)

(72) Inventors: Leandro Vacirca, Dalmine (BG) (IT); Angelo Cleber, Dalmine (BG) (IT); Luciano Di Maìo, Milano (IT)

(21) Appl. No.: 15/320,664

(22) PCT Filed: Apr. 22, 2015
(86) PCT No.: PCT/EP2015/058698

§ 371 Date: Dec. 20, 2016

(30) Foreign Application Priority Data
Jun. 18, 2014 (EP) 14172992.1

(51) Int. Cl. H01H 9/16; H01H 71/12

(52) U.S. Cl. CPC H01H 9/161; H01H 71/12; H01H 2219/06; H01H 2219/066

(57) ABSTRACT

The invention relates to a switching device for a MV electric power distribution network. The switching device comprises electric contacts, which are electrically connectable to a conductor of said electric power distribution network, and a control unit. The switching device comprises signalling means emitting visible light externally to said switching device, said signalling means being controlled by said control unit.

The present invention relates to a switching device for medium voltage (MV) power distribution networks.

Within the framework of the present invention, the term “medium voltage” relates to voltages higher than 1 kV AC and 1.5 kV DC and lower than 72 kV AC and 100 kV DC.

As is known, switching devices, such as automatic sectionalizers, are operatively associated to the phase conductors of a MV electric power distribution network to automatically restore or interrupt the electric continuity of this latter.

Generally, automatic sectionalizers cannot operate when fault currents (e.g. short-circuit currents or overload currents) flow along the phase conductors. Fault currents are in fact typically interrupted by properly arranged circuit breakers or reclosers.

Nowadays, an operator is not able to know whether a traditional sectionalizer has been properly installed on the field before this latter starts operating.

The blind commissioning of these devices has remarkable drawbacks, since it may lead to undesired electric power outages of large branches of the electric power distribution network.

These problems are even more critical when a sectionalizer is installed in outdoor overhead electric power distribution lines, for which maintenance interventions are quite time consuming and expensive.

A way to face this issue is to provide the control unit of the sectionalizer with a communication module, which allows it to be wireless interrogated by a remote device.

This solution entails an increase of the overall size and industrial costs of the switching device, which may be unacceptable in some applications.

In the market, it is thus still felt the need for technical solutions that are capable of overcoming the technical issues described above.

In order to respond to this need, the present invention provides a switching device for a MV electric power distribution network, according to the following claim 1 and the related dependent claims.

Further characteristics and advantages of the present invention shall emerge more clearly from the description of preferred but not exclusive embodiments thereof, illustrated purely by way of example and without limitation in the attached drawings, in which:

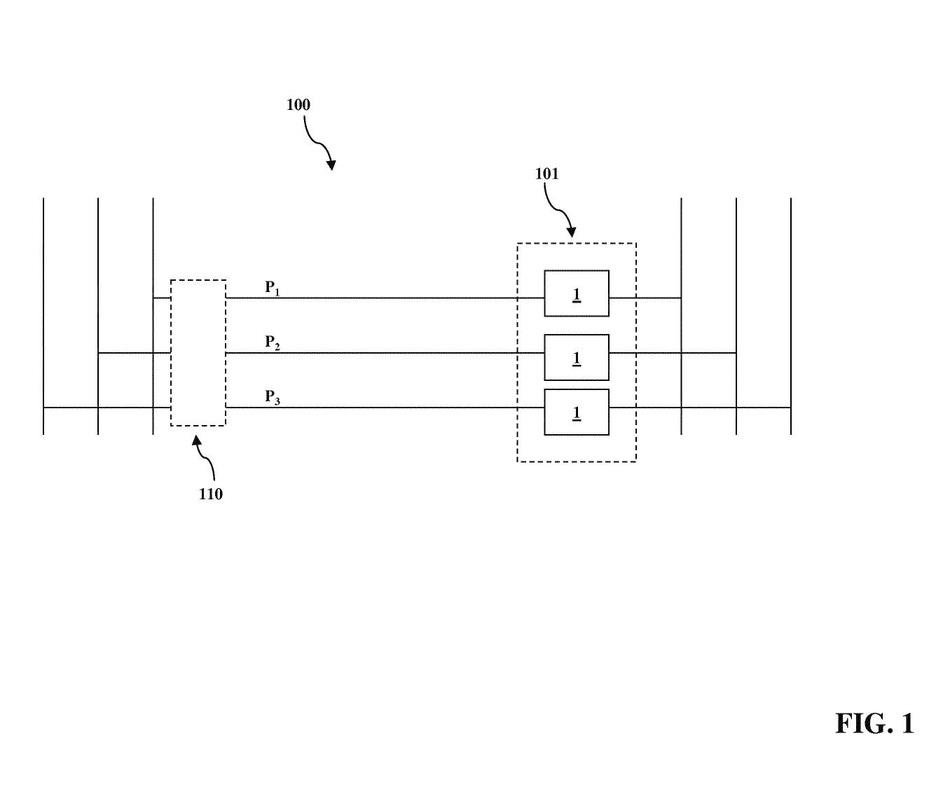

FIG. 1 is a diagram that schematically shows a MV electric power distribution network comprising a plurality of switching devices, according to the present invention, operatively associated to the phase conductors;

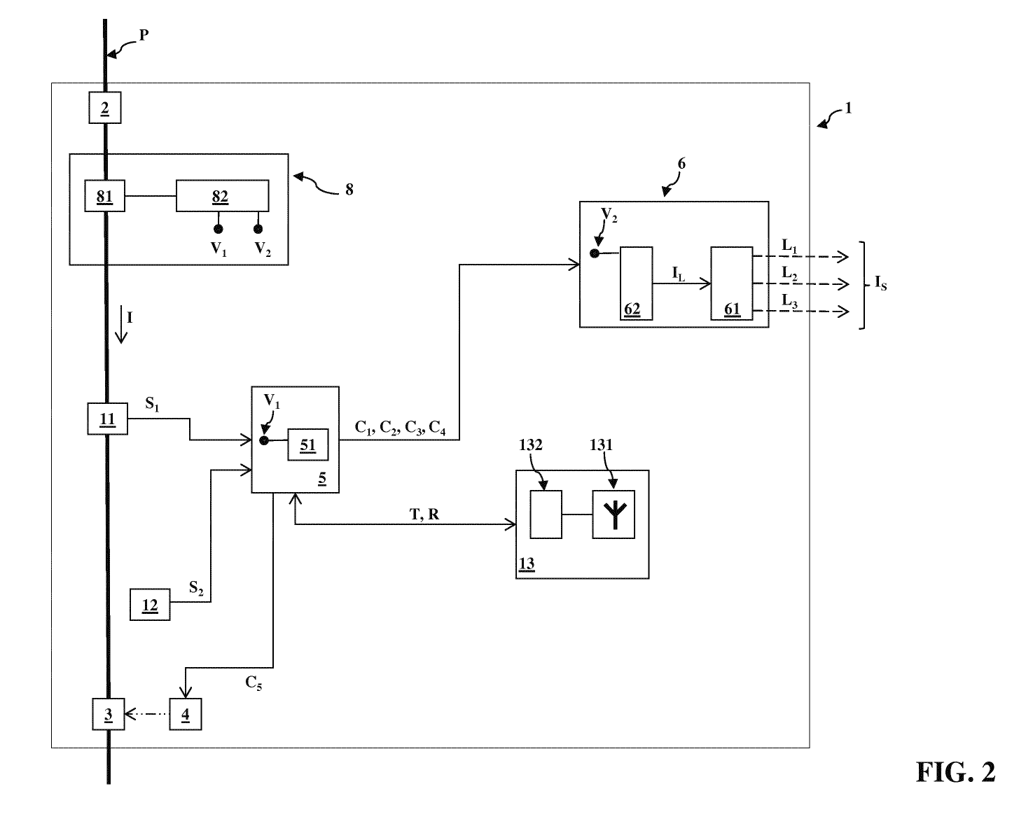

FIG. 2 is a diagram that schematically shows the structure of the switching device, according to the present invention;

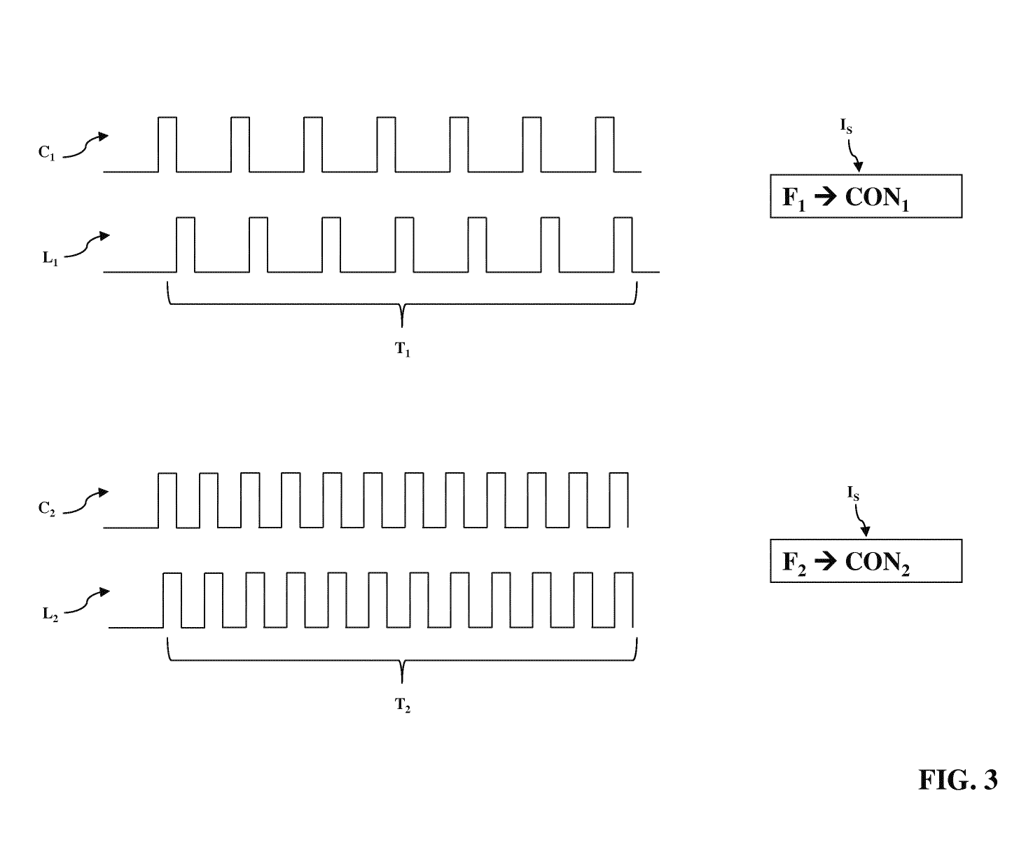

FIG. 3 is a diagram that schematically shows the functioning of the switching device, according to the present invention;

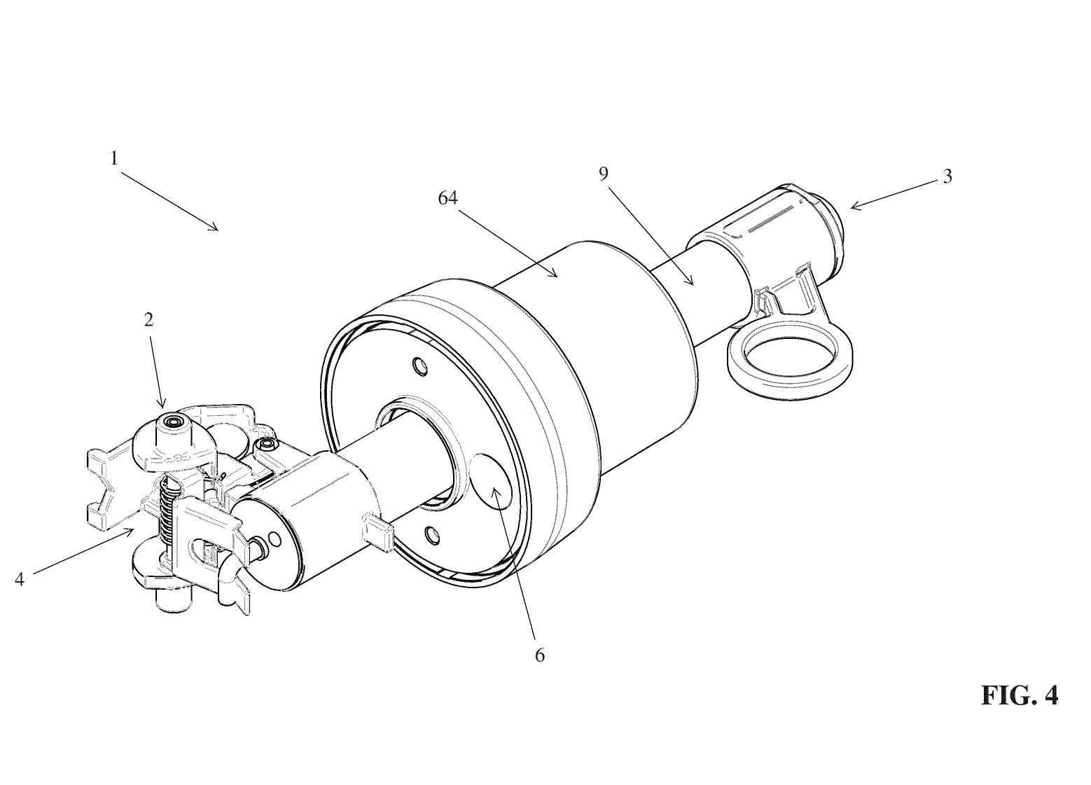

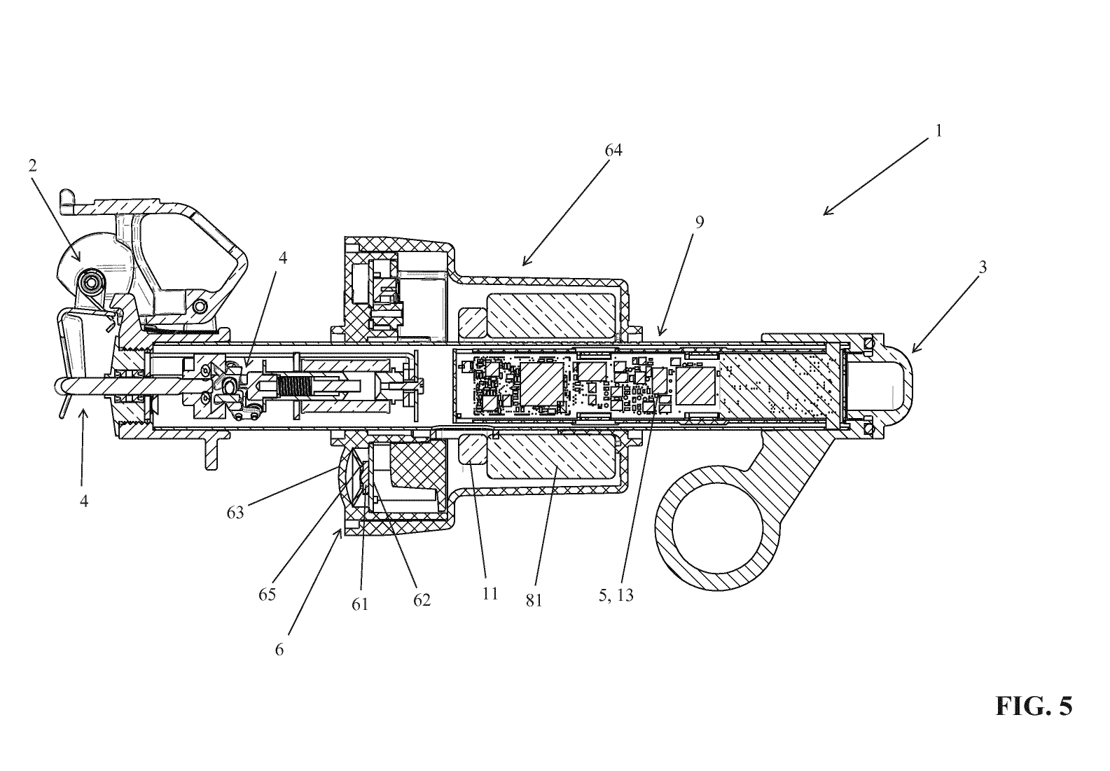

FIGS. 4-5 schematically show an embodiment of the switching device, according to the present invention.

With reference to the mentioned figures, the present invention relates to a switching device 1 for a MV electric power distribution network 100, e.g. an overhead MV power distribution line.

The switching device 1 is operatively associated to a conductor P of the electric power distribution network 100, which is preferably a phase conductor (FIG. 2).

The switching device 1 comprises electric contacts 2, 3 that are electrically connectable to the conductor P.

In operation, at least one of said electric contact (e.g. the electric contact 3) can be separated from a corresponding electric contact (not shown) of the conductor P, so that the electrical continuity of upstream and downstream portions (referring to the position of the disconnectable electric contact 3) of the conductor P can be interrupted.

In general, the switching device 1 is capable to interrupt currents along the conductor P and is advantageously arranged to intervene in coordination with at least a circuit breaker or recloser 110 that is operatively associated to the electric power distribution network 100 to provide protection against short-circuit currents and/or overload currents (FIG. 1).

Preferably, the switching device 1 is an automatic sectionalizer, e.g. for an overhead power distribution line.

The switching device 1 advantageously comprises release means 4 to allow separation of at least one of said electric contacts (e.g. the electric contact 3) from the conductor P.

The release means 4 may comprise an electro-mechanical or electro-magnetic release device or actuator, which is tripped by suitable control signals C₅.

The switching device 1 comprises a control unit 5, which preferably comprises a digital processing device 51 (for example a microcontroller) that is capable to execute software instructions (stored in a memory) for managing the operating life of the switching device 1, e.g. for generating/receiving data signals, processing data, generating/receiving control signals and the like.

The control unit 5 may comprise further electronic circuits (not shown) operatively connected to the digital processing device 51.

According to the invention, the switching device 1 comprises signalling means 6 operatively connected to the control unit 5, so as to be controlled by this latter (in particular by the digital processing device 51).

The signalling means 6 comprise a light source 61 adapted to emit visible light.

Preferably, the light source 61 emits red light. This solution ensures improved light transmission efficiency and it is particularly suitable for outdoor installations.

In some embodiments of the invention, the light source 61 is adapted to emit visible light of different colours (preferably including red colour).

Preferably, the light source 61 comprises one or more LEDs (Light Emitting Diodes).

Preferably, the signalling means 6 comprise a driving circuit 62, which is electrically connected with the light source 61 and the control unit 5.

The driving circuit 62 is adapted to receive suitable control signals (e.g. the control signals C₁, C₂, C₃, C₄ mentioned in the following) from the control unit 5 and provide one or more driving signals I_{L} to the light source 61 to operate this latter in response to said control signals.

As an example, when the light source 61 comprises one or more LEDs, the driving circuit 62 is capable to provide suitable driving currents I_{L} to operate said LEDs in response to control signals received from the control unit 5.

The light source 61 is arranged so that the emitted light is observable from the external of the switching device 1, e.g. by an operator accessing to the site where the switching device 1 is installed.

The switching device 1 comprises an accessory module 64 that accommodates the signalling means 6 (FIGS. 4-5).

Advantageously, the module 64 is positioned so that the light source 61 can emit light towards the environment external to the switching device 1.

Preferably, the light source 61 is optically coupled to an optical lens 63 and to a reflecting body 65, which are part of said signalling means 6.

Conveniently, the lens 63 forms an external transparent wall portion of the module 64, through which the light source 61 can emit light.

The reflecting body 65 improves light transmission whereas the lens 63 allows reducing light dispersion phenomena and ensures protection against external environmental agents.

As mentioned above, the functioning of the signalling means 6 is controlled by the control unit 5.

According to the invention, the control unit 5 is adapted to provide one or more control signals C₁, C₂, C₃ to the signalling means 6, so that the light source 61 emits one or more light signals L₁, L₂, L₃ indicative of corresponding operating conditions CON₁, CON₂ of the switching device 1.

In other words, the signalling means 6 are controlled by the control unit 5 in such a way that the light source 61 emits light signals L₁, L₂, L₃ providing (when visually observed) coded information I_{S} about corresponding operating conditions of the switching device 1.

Preferably, the control unit 5 sends the control signals C₁, C₂, C₃ to the driving circuit 62, which generates suitable driving signals I_{L} to operate the light source 61 in response to said control signals, so that the light source 61 generates the light signals L₁, L₂, L₃.

Preferably, the control unit 5 is adapted to provide first control signals C₁ to the signalling means 6, so that the light source 61 emits first pulsed light signals L₁ having one or more first sequences T₁ of light pulses indicative of first corresponding operating conditions CON₁ of the switching device 1, during a start-up functioning of this latter.

Within the framework of the present invention the term “start-up functioning” relates to the customary functioning of the switching device 1 before its entering into service, i.e. during or immediately after its installation on the field.

Preferably, the control unit 5 generates the control signals C₁ after having performed an internal check (preferably as soon as it starts operating) or in response to data/control signals received from other devices.

Preferably, the first sequences T₁ of light pulses are configured to provide coded information I_{S} indicative of the corresponding operating conditions CON₁.

During each sequence T₁, the light source 61 emits light pulses having a given time distribution. Such a time distribution is the parameter providing observable coded information I_{S} indicative of a corresponding operating condition CON₁.

The first light signals L₁ may be indicative of a correct configuration of the control unit 5 or about possible faults.

By observing the light signals L₁, an operator can easily learn whether the switching device 1 has been properly installed, whether the commissioning of the switching device 1 has been successful, whether the configuration settings of the control unit 5 have been accepted, and the like.

Visual information I_{S} provided by the light signals L₁ is quite useful to increase the confidence that the switching device 1 has been properly installed and works correctly, thereby increasing the reliability of the installation.

This brings remarkable advantages, particularly when the switching device 1 is installed in overhead lines.

Preferably, the control unit 5 is adapted to provide second control signals C₂ to the signalling means 6, so that the light source 61 emits second pulsed light signals L₂ having one or more second sequences T₂ of light pulses indicative of corresponding second operating conditions CON₂ of the switching device 1, during a normal functioning of this latter.

Within the framework of the present invention, the term “normal functioning” relates to the customary functioning of the switching device 1 after its entering into service.

Preferably, the control unit 5 generates the control signals C₂ after having performed an internal check (preferably at given time intervals) or in response to data/control signals received from other devices (e.g. sensors operatively connected to the control unit 5).

Preferably, the second sequences T₂ of light pulses are configured to provide coded information I_{S} indicative of the corresponding operating conditions CON₂.

During each sequence T₁, the light source 61 emits light pulses having a given time distribution. Such a time distribution is the parameter providing observable coded information I_{S} indicative of a corresponding operating condition CON₂.

The light signals L₂ may be indicative of recent manoeuvres of the switching device 1 or measured electrical quantities (e.g. of the current I flowing along the conductor P).

By observing the light signals L₂, an operator can immediately learn whether the switching device 1 works properly, during its normal functioning period.

Visual information I_{S} provided by the light signals L₂ is quite useful to understand electric power balance across a line branch, identify critical overloads or persisting line fault conditions or persistent transient faults.

This facilitates planning of maintenance interventions, thereby reducing maintenance time and costs.

As mentioned above, the first and second sequences T₁, T₂ of light pulses of the first and second light signals L₁, L₂ comprise light pulses having given time distributions corresponding to given operating conditions CON₁, CON₂ of the switching device 1.

In some embodiments of the invention, each sequence T₁, T₂ of light pulses comprises a given number of light pulses (said number providing the coded information I_{S}), which corresponds to a given operating condition CON₁, CON₂ of the switching device 1.

In other embodiments of the invention, each sequence T₁, T₂ of light pulses comprises light pulses having a given duty-cycle (said duty-cycle providing the coded information I_{S}), which corresponds to a given operating condition CON₁, CON₂ of the switching device 1.

Preferably, each sequence T₁, T₂ comprises light pulses having a given frequency F (said frequency providing the coded information I_{S}), which corresponds to a given operating condition CON₁, CON₂ of the switching device 1.

Obviously, the control unit 5 may provide different kinds of first and second control signals C₁, C₂ to the signalling means 6, so that the light source 61 emits different kinds of first and second pulsed light signals L₁, L2.

Each different light signal L₁, L₂ is characterised by a corresponding sequence T₁, T₂ of light pulses, which is configured to be indicative of a corresponding operating condition CON₁, CON₂ of the switching device 1.

Preferably, the sequences of light pulses T₁, T₂ are repeated at given time intervals, so that they can be easily observed by an operator.

It is observed that a missing emission of the light signals L1, L2 by the light source 61 may per se be indicative of the presence of faults. Thus, an operator can acquire information on the operating conditions of the switching device 1 even when the signals L₁, L₂ cannot be observed.

An example of functioning of the switching device 1 is shown in FIG. 3.

In this example, the light source 61 is supposed to comprise a single LED.

The switching device 1 is capable of providing visual information of its operating conditions before its entering into service.

At a start-up functioning of the switching device 1 (e.g. immediately after the commissioning), the control unit 5 executes an internal check of the operating conditions of the switching device 1.

In response to said internal check, the control unit 5 provides the driving circuit 62 with a first control signal C₁ having the shape of square wave.

In this case, the first control signal C₁ has a given first duty cycle DC₁ and a given first frequency F₁.

In response to the control signal C₁, the driving circuit 62 generates a driving current I_{L} to operate the LED 61.

The LED 61 emits a first pulsed light signal L₁ having a first sequence T₁ of light pulses characterised by a frequency F₁ and duty cycle DC₁.

The sequence T₁ of light pulses is advantageously repeated periodically.

In this case, the duty cycle DC₁ of the light pulses may be advantageously selected to reduce power consumption (without providing any useful information content).

Instead, the frequency F₁ of the light pulses is advantageously selected to be indicative of a first corresponding coded operative condition CON₁ of the switching device 1.

For example, the frequency F₁ may be selected to indicate an operative state of the switching device 1, which corresponds to a correct and complete installation.

By simply observing the blinking light signal L₁ emitted by LED 61, an operator can thus acquire information I_{S} related to an operative condition of the switching device 1, before its entering into service.

On the other hand, if the blinking signal L₁ is not emitted, the operator will understand that a fault occurred during the commissioning of the switching device 1.

Of course, the signalling means 6 may be controlled by the control unit 5, so that the light source 61 emits pulsed light signals L₁ having different frequencies of the light pulses, each frequency corresponding to a given operating condition CON₁ of the switching device 1.

For example, different pulsed light signals L₁ indicating different typology of faults may be emitted.

It is also understood that, in general, the sequences T₁ of light pulses (or the light pulses themselves) of the light signals L₁ may be differently shaped or may have different time distributions from those shown in FIG. 3, depending on the parameter selected (frequency, duty-cycle, duration, etc.) to provide coded information I_{S} indicative of corresponding operating conditions CON₁ of the switching device 1.

The switching device 1 is capable of providing visual information of its operating conditions after its entering into service.

During the normal operating life of the switching device 1, the control unit 5 executes periodically an internal check or receives data signals indicative of measured electrical quantities.

In response to said internal check or data signals, the control unit 5 provides the driving circuit 62 with a second control signal C₂, which makes the LED 61 to emit a second pulsed light signal L₂ having a second sequence T₂ of light pulses characterised by a second frequency F₂.

The frequency F₂ of the light pulses is advantageously selected to be indicative of a second coded operative condition CON₂ of the switching device 1.

For example, the frequency F₂ may be selected to indicate that a manoeuvre of the switching device 1 has occurred or to provide a measurement value in coded form.

Again by simply observing the blinking light signal L₂ emitted by LED 61, an operator can acquire information I_{S} related the actual operative status of the switching device 1.

Also in this case, the signalling means 6 may be controlled by the control unit 5, so that the light source 61 emits pulsed light signals L₂ having different frequencies of the light pulses, each frequency corresponding to a given operating condition CON₂ of the switching device 1.

Further, in general, the sequences T₂ of light pulses (or the light pulses themselves) of the light signals L₂ may be differently shaped or may have different time distributions from those shown in FIG. 3, depending on the parameter selected (frequency, duty-cycle, duration, etc.) to provide coded information I_{S} indicative of the corresponding operating conditions CON₂ of the switching device 1.

According to an embodiment of the invention, the switching device 1 comprises first sensing means 11 operatively connected to the control unit 5.

The sensing means 11 provide first sensing signals S₁ indicative of the current I flowing along the conductor P to the control unit 5.

Preferably, the sensing means 11 comprise a measuring current transformer that is operatively coupled to the conductor P and is electrically connected to the processing means 51.

The control unit 5 is advantageously adapted to provide the second control signals C₂ to the signalling means 6 in response to the sensing signals S₁ received from the sensing means 11.

In this case, the signalling means 6 are operated by the control unit 5, so that the light source 61 emits light signals L₂ indicative of corresponding ranges of values of a current I flowing along the conductor P, during the normal functioning of the switching device 1.

Advantageously, the light source 61 provides light signals L₂ having a second sequence T₂ of light pulses (repeated periodically) characterised by a frequency of the light pulses that varies according to the measured current range for the current I.

If the current range of the current I varies, the frequency of the light pulses will vary accordingly. Thus, a given frequency will be indicative of a first range of current values whereas other frequencies will be indicative of other corresponding ranges of current values.

By observing the blinking light signals L₂ emitted by the light source 61, an operator can immediately acquire information on the magnitude of the current I along the conductor P.

Even if the linking signals L₂ does not provide precise measurements of the current I, they provide useful information for managing the operation of the switching device 1 and for safety purposes.

As mentioned above, the light source 61 may be advantageously adapted to emit light signals of different colours.

For example, the light source 61 may comprise a plurality of LEDs emitting light of different colours.

Preferably, the control unit 5 is adapted to provide third control signals C₃ to the signalling means 6 to operate these latter, so that the light source 61 emits third light signals L₃ having colours indicative of corresponding operating conditions CON₁, CON₂ of the switching device 1.

In this case, the colour of the light signals L₃ is the parameter providing coded information I_{S} related to the operating conditions CON₁, CON₂ of the switching device 1.

As an example, a light signal L₃ of a given colour may be indicative of the recent occurrence of faults or it may indicate the main direction of electric power flow along the conductor P or the like.

In a possible embodiment, the signalling means 6 are operated so that the light source 61 emits third light signals L₃ having different colours, wherein each of said colours is indicative of a corresponding operating condition CON₁, CON₂ of the switching device 1.

Preferably, in case the light source 61 comprises a plurality of LEDs capable of emitting different colours, the signalling means 6 are operated by the control unit 5, so that one or more main LEDs emit first or second pulsed light signals L₁, L₂ of a same given colour (preferably a red colour) and one or more auxiliary LEDs emit third light signals L₃ of different colours, each colour being indicative of a corresponding operating condition CON₁, CON₂ of the switching device 1.

Preferably, the control unit 5 is capable of operating the signalling means 6, so as to vary the light intensity of the light signals L₁, L₂, L₃ emitted by the light source 61.

In particular, the control unit 5 is adapted to provide one or more fourth control signals C₄ to the signalling means 6, so that the light source 61 emits light signals L₁, L₂, L₃ of variable light intensity.

Preferably, the switching device 1 comprises second sensing means 12 operatively connected to the control unit 5.

The sensing means 12 provide second sensing signals S₂ indicative of the environmental light external to the switching device 2.

Preferably, the sensing means 12 comprise a light sensor that is arranged so as to detect the environmental light out of the switching device 1.

Preferably, the control unit 5 provide the control signals C₄ in response to the sensing signals S₂.

In this way, the signalling means 6 are operated so that the light source 61 emits light signals L₁, L₂, L₃ having a light intensity that varies as a function of the external environmental light, e.g. depending on the daytime or weather conditions.

Preferably, the control unit 5 is adapted to provide one or more fifth control signals C₅ to control the actuation means 4. In this way, the control unit 5 can control the manoeuvres of the electric contacts 2, 3, according to the needs.

Preferably, the switching device 1 comprises a communication unit 13 operatively connected to the control unit 5.

The communication unit 13 is provided with at least an antenna element 131 for wireless communication with other remote devices.

The communication unit 13 is capable of wireless communicating with other remote devices (not shown), e.g. with the control units of other switching devices, Intelligent Control Devices (IEDs), relays, SCADA systems or the like.

The communication unit 13 is capable of managing the wireless communication with said remote devices, e.g. by means of suitable communication protocols such as Zigbee™, Bluetooth™ or the like.

The communication unit 13 is controlled by the control unit 5 and can interact with this latter for managing the wireless communication with the remote devices.

The communication unit 13 preferably comprises an interface circuit 132 that is operatively connected with the control unit 5 for sending/receiving transmission/reception signals to/from this latter.

The control unit 5 is adapted to generate one or more transmission signals T for the interface circuit 132.

Transmission signals T may comprise command signals for the interface circuit 132 and/or data signals (e.g. data packages) to be transmitted by the interface circuit 132 via the antenna unit 131.

The control unit 5 is adapted to receive one or more reception signals R from the interface circuit 131.

Reception signals R may comprise command signals and/or data signals (e.g. data packages) for the processing means 51, which have been generated by the interface circuit 131 and/or which have been received by the interface circuit 132 from remote devices, via the antenna unit 131.

Preferably, the switching device 1 comprises a power supply unit 8, which is operatively connected to the control unit 5 and to the signalling means 6 to provide electric power to these latter.

Preferably, the switching device 1 is of the “self-supplied” type, i.e. it comprises a power supply unit 8 that is capable to draw electric power to feed the internal components from the conductor P, to which the switching device 1 is operatively associated.

Preferably, the power supply unit 8 comprises a first power harvesting circuit 81, which is operatively coupled to the conductor P to draw electric power from this latter.

Preferably, the power harvesting circuit 81 comprises a current transformer electrically connected to one or more interface circuits.

Preferably, the power supply unit 8 comprises a second power supply circuit 82, which is electrically connected to the first power harvesting circuit 81.

Preferably, the power supply unit 8 is capable to provide a first power supply voltage V₁ to feed the control unit 5 (in particular the processing device 51) and a second power supply voltage V₂ to feed the signalling means 6, in particular the driving circuit 62.

Preferably, the power supply circuit 82 comprises one or more converter circuits that are electrically connected to the mentioned interface circuits of the power harvesting circuit 81.

Preferably, the accessory module 64, which accommodates the signalling means 6, defines an internal volume, in which the current transformers of the sensing means 11 and of the power harvesting circuit 81 are positioned as well.

Preferably, the switching device 1 comprises a conductive casing 9 that is electrically connected to the electric contacts 2, 3.

The conductive casing 9 accommodates the control unit 5, the communication unit 13 and, at least partially, the release means 4.

The conductive casing 9 is electrically connected to the conductor P of the power distribution line through the electric contacts 2, 3 to allow the passage of current towards between these latter.

Preferably, the accessory module 64 is operatively connected to the conductive casing 9.

Preferably, the accessory module 64 has a toroid shape defining a passing cavity through which the conductive casing 9 is positioned.

In a further aspect, the present invention comprises a MV switching apparatus 101 comprising a plurality of switching devices 1 (FIG. 1).

In the switching apparatus 101, each switching device 1 is operatively associated to a conductor of the electric power distribution network 100.

Preferably, the switching apparatus 101 is a disconnecting apparatus for an overhead line 100 comprising a plurality of sectionalizers 1, each of which is operatively associated to a phase conductor P₁, P₂, P₃ of the overhead line.

The switching device 1, according to the invention, has remarkable advantages with respect to the state of the art.

Thanks to the signalling means 6, the switching device 1 is capable of providing a self-diagnostic visual indication of its operative status at different periods of its operating life, in particular at the start-up functioning and during its normal operation.

An operator can visually learn whether the installation of the switching device 1 has been successful before the switching device 1 enters into service. It is thus possible to immediately intervene on the switching device 1 in case malfunctions are signalled.

Further, during the normal functioning of the switching device, an operator can easily acquire information about the operative status of the switching device 1, e.g. information about the current flowing along the conductor P.

This allows improving the operating management of the switching device 1 and reducing maintenance time and costs.

The switching device 1 is particularly adapted for being employed in an overhead line 100, in particular to be operatively associated to a phase conductor P1, P2, P3 thereof.

The switching device 1 is of relatively easy and cost-effective realization at industrial level and practical implementation on the field.

1. A switching device for a MV electric power distribution network, said switching device comprising electric contacts, which are electrically connectable to a conductor of said electric power distribution network, and a control unit for managing the operation of said switching device, said control unit comprises signalling means operatively connected to said control unit, said signalling means comprising a light source adapted to emit visible light observable externally to said switching device, said control unit being adapted to provide control signals to control said signalling means, so that said light source emits light signals indicative of corresponding operating conditions of said switching device.

2. A switching device, according to claim 1, wherein said control unit is adapted to provide first control signals to control said signalling means, so that said light source emits first pulsed light signals having one or more first sequences of light pulses indicative of corresponding first operating conditions of said switching device, during a start-up functioning of said switching device.

3. A switching device, according to claim 1, wherein said control unit is adapted to provide second control signals to control said signalling means, so that said light source emits second pulsed light signals having, one or more second sequences of light pulses indicative of corresponding second operating conditions of said switching device, during a normal functioning of said switching device.

4. A switching device, according to claim 3, which further comprises first sensing means operatively connected to said control unit, said first sensing means providing first sensing signals, which are indicative of the current (flowing along said conductor, to said control unit, said control unit being adapted to provide said second control signals to control said signalling means in response to said first sensing signals, so that said light source emits second pulsed light signals having one or more second sequences of light pulses indicative of corresponding ranges of values of the current flowing along said conductor.

5. A switching device, according to claim 1, wherein said light source is adapted to emit light signals of different colours, said control unit being adapted to provide third control signals to control said signalling means, so that said light source emits third light signals having colours indicative of corresponding operating conditions of said switching device.

6. A switching device, according to claim 1, wherein said control unit is adapted to provide fourth control signals to control said signalling means, so that said light source emits light signals having variable light intensity.

7. A switching device, according to claim 6, comprises second sensing means operatively connected to said control unit, said second sensing means providing second sensing signals, which are indicative of the external environmental light level, to said control unit, said control unit providing said fourth control signals to control said signalling means in response to said second sensing signals, so that said light source emits light signals having variable light intensity depending on the external environmental light.

8. A switching device, according to claim 1, which further comprises a power supply unit, which is operatively connected to said control unit, said power supply unit comprising a first power harvesting circuit, which is operatively coupled to said conductor to draw electric power from said conductor, and a second power supply circuit, which is electrically connected to said first power harvesting circuit, said second power supply circuit being adapted to provide a first power supply voltage to feed said control unit and a second power supply voltage to feed said signalling means.

9. A switching device, according to claim 1, wherein said light source comprises one or more LEDs.

10. A switching device, according to claim 1, which further comprises an accessory module that accommodates said signalling means.

11. A switching device, according to claim 1, wherein said light source is operatively coupled to an optical lens.

12. A switching device, according to claim 1, wherein said light source is operatively coupled to a reflecting body.

13. A switching device, according to claim 1. wherein said switching device is an automatic sectionalizer.

14. A switching device, according to claim 13, wherein said automatic sectionalizer is for a MV overhead electric power distribution line.

15. A MV disconnecting apparatus comprising:
a switching device including electric contacts which are electrically connectable to a conductor of an electric power distribution network: and
a control unit for managing the operation of said switching device, said control unit comprises signalling means operatively connected to said control unit, said signalling means comprising a light source adapted to emit visible light observable externally to said switching device, said control unit being adapted to provide control signals to control said signalling means, so that said light source emits light signals indicative of corresponding operating conditions of said switching device.

16. A switching device, according to claim 2, wherein said control unit is adapted to provide second control signals to control said signalling means, so that said light source emits second pulsed light signals having one or more second sequences of light pulses indicative of corresponding second operating conditions of said switching device, during a normal functioning of said switching device.

17. A switching device, according to claim 16, which further comprises first sensing means operatively connected to said control unit, said first sensing means providing first sensing signals, which are indicative of the current flowing along said conductor, to said control unit, said control unit being adapted to provide said second control signals to control said signalling means in response to said first sensing signals, so that said light source emits second pulsed light signals having one or more second sequences of light pulses indicative of corresponding ranges of values of the current flowing along said conductor.

18. A switching device, according to claim 2, wherein said light source is adapted to emit light signals of different colours, said control unit being adapted to provide third control signals to control said signalling means, so that said light source emits third light signals having colours indicative of corresponding operating conditions of said switching device.

19. A switching device, according to claim 2, wherein said control unit is adapted to provide fourth control signals to control said signalling means, so that said light source emits light signals having variable light intensity.

20. A switching device, according to claim 6, which further comprises second sensing means operatively connected to said control unit, said second sensing means providing second sensing signals, which are indicative of the external environmental light level, to said control unit, said control unit providing said fourth control signals to control said signalling means in response to said second sensing signals, so that said light source emits light signals having variable light intensity depending on the external environmental light.
